(19) United States
(12) Patent Application Publication
(10) Pub. No.: US 2022/0251363 A1
(43) Pub. Date: Aug. 11, 2022

(54) Plasticized PVC hose and method for manufacturing thereof

(71) Applicant: FITT S.p.A., Sandrigo (VI) (IT)

(72) Inventor: Luca Battaglia, Bassano del Grappa (VI) (IT)

(21) Appl. No.: 17/626,908

(22) PCT Filed: Jul. 14, 2020
(86) PCT No.: PCT/IB2020/056592

§ 371 Date: Jan. 13, 2022

(30) Foreign Application Priority Data
Jul. 24, 2019 (IT) 102019000012819

(51) Int. Cl. C08L 27/06; C08J 3/18; C08J 3/12; B29C 48/10; B29C 48/00

(52) U.S. Cl. CPC C08L 27/06; C08J 3/18; B29K 2027/06; B29C 48/10; B29C 48/022; C08J 3/12

(57) ABSTRACT

A flexible or spiraled hose manufactured from a plasticized thermoplastic PVC compound, which includes: (A) 100 phr of a PVC matrix in suspension having a K factor measured according to DIN EN ISO 1628-2 greater than or equal to 98′ (B) from 100 phr to 250 phr of a plasticizer agent; (C) from 0.5 phr to 5 phr of a stabilizer agent; (D) from 0.1 to 10 phr of a co-stabiliser agent, (E) from 0 to 10 phr of an additive. The plasticized thermoplastic PVC compound has a Shore A hardness measured according to UNI EN ISO 868 between 30 Sh A and 60 Sh A, preferably between 30 Sh A and 50 Sh A.

### FIELD OF THE INVENTION

The present invention relates to the technical field of flexible or spiralled hoses, and it relates in particular to the use of a plasticised PVC compound for manufacturing flexible or spiralled hoses, a method for manufacturing such hose, as well as a flexible or spiralled hose made of such compound.

### Definitions

In the present text, the value “phr” is used to indicate the number of parts by weight of the component per 100 parts of resin, i.e. of the component (A).

In the present text, the term “particle size distribution” is used to indicate the dimensional distribution curve of the particle diameter measured according to DIN EN ISO 4610.

In the present text, the term “volatility” is used to indicate a measurement of the weight loss of the PVC compound, determined using three samples in the form of square plates in the plan view, with a side measuring 3 cm and a thickness equal to 2 mm, obtained from a sheet of compound manufactured by means of calendering and having the same dimensions to subject the surface height in question to heat. The samples are weighed so as to be subsequently arranged in a forced air ventilation oven of the M250-VF type marketed by ATS FAAR Industries srl, at a predefined temperature, in the present example equal to 80° C. The volatility is then calculated as an average measurement of the possible percent weight loss of each sample after a sufficient time interval, in the present example equal to 168 h, at the aforementioned predefined temperature.

Below is the formula used for calculation:

$$Weight loss = \frac{{W}_{1} - {W}_{2}}{{W}_{1}} * 100 ( \% )$$

wherein:
W₁ is the weight of the sample at the beginning of the test;
W₂ is the weight of the sample at the end of the test.

In the present text, the term “PVC matrix” and its derivatives is used to indicate any resin or mixture of resins containing or consisting of polyvinyl chloride.

In the present document, the term “plasticiser agent” and its derivatives is used to indicate a compound or a mixture of compounds which can increase the flexibility, processability and extension of the polymer in which it is incorporated. A plasticiser agent may reduce the viscosity of the mixture, lower the phase transition temperatures of the second order, and the elastic modulus of the product.

In the present text, the term “stabiliser agent” and its derivatives is used to indicate a compound or a mixture of compounds which can intercept small molecules resulting from the degradation of the polymer, for example HCl, to form a more stable intermediate compound.

In the present text, by the term “filler” and its derivatives is used to indicate solid materials made of particles or fibrosis, substantially chemically inert, with the function of fillers.

In the present text, the term “additive” and its derivatives is used to indicate a substance which, when added to a compound, improves one or more characteristics thereof.

### STATE OF THE ART

Flexible and spiralled hoses made of plasticized PVC are known.

The former generally have one or more tubular layers made of plasticized PVC, and may or may not comprise one or more reinforcement textile layers, generally knitted or cross-hatched. The plasticized PVC layers are obtained by extrusion, while the knitted or cross-hatched layers are obtained by means of suitable circular knitting or cross-hatching machines. This type of pipe has various uses, for example transportation of drinking water for irrigating gardens and/or plants.

The spiralled hoses generally have a main body made of plasticised PVC in which a reinforcement spiral, also normally made of plasticised PVC, is embedded. Such hoses are obtained by coextruding a webbing having a core made of the material constituting the reinforcement spiral and an outer shell made of the material constituting the main body, and then winding the webbing on a cylindrical spindle so as to create the hose by adhering the facing walls of the hose being processed and of the webbing. Such type of hose is generally used for the transportation of water in swimming pool or SPA facilities.

A drawback of known flexible hoses lies in their overall dimensions. As a matter of fact, they are generally packaged and transported in circular coils, which have large overall dimensions. The overall dimensions thereof are also high during storage after use. As a matter of fact, trolleys or saddles are used for this purpose, and the overall space occupied by the latter and by the hose is considerably high.

On the other hand, the spiralled hoses are by nature laid underground and come into contact with water having a high chlorine content. As a result, the severe operating conditions make them susceptible to cracks and damage, with the result that they must be replaced after costly and demanding excavation work.

### SUMMARY OF THE INVENTION

An object of the present invention is to overcome the drawbacks illustrated above by providing a highly efficient flexible and/or spiralled hose.

Another object of the invention is to provide a flexible hose having minimum overall dimensions.

Another object of the invention is to provide a durable spiralled hose.

These and other objects which will be more apparent hereinafter, are achieved by the use of a plasticised PVC compound for manufacturing flexible and/or spiralled hoses, according to what is described and/or claimed herein.

Generally, the flexible and/or spiralled hoses according to the present invention may be useful for transporting any fluid, in particular any liquid.

In particular, the hose may be an irrigation hose or garden hose for the transportation of drinking water, while the spiralled hose may be a swimming pool hose for the transportation of water in swimming pool or SPA facilities.

The plasticised thermoplastic PVC compound may consist of:
(A) 100 phr of a PVC matrix in suspension;
(B) from 100 phr to 250 phr of at least one plasticiser agent;
(C) from 0.5 phr to 5 phr of at least one stabiliser agent;
(D) from 0.1 to 10 phr of at least one co-stabilizer agent;
(E) from 0 to 10 phr of at least one additive.

The PVC matrix (A) may have a K factor measured according to DIN EN ISO 1628-2 greater than or equal to 98, preferably equal to 99 or 100.

As known, the K value is a dimensionless index which can be directly related to the molecular weight of a PVC resin and it is used to compare various types of PVC resins.

Furthermore, the PVC matrix (A) may have a particle size distribution measured according to DIN EN ISO 4610 of:
not more than 90% of particles remaining on a 0-063 mm mesh sieve;
not more than 5% of particles remaining on a 0.250 mm mesh sieve.

Generally, the particles of the PVC matrix (A) may have a porosity measured in terms of absorption of plasticiser according to DIN 53417/1 comprised between 34% and 55%, preferably comprised between 40% and 50%. Even more preferably, such porosity may be 45%.

The PVC matrix (A) may also be a resin in suspension whose bulk density calculated according to UNI EN ISO 60 may be comprised in a range between 0.400 g/ml and 0.500 g/ml, preferably 0.440 g/ml.

In the aforementioned plasticised PVC compound, any type of per se known plasticiser may be used, for example DINP, DOTP, TOTM, DIDP, polymeric plasticisers, DOA DIDA, DINCh®, vegetable plasticizers (epoxidized methyl esters) or the like. In particular, the content of the same plasticiser agent (B) may be in a range between 130 phr and 210 phr.

In the aforementioned plasticised PVC compound, any type of per se known stabiliser agent, for example of the Ca—Zn, Ba—Zn type, organic Ca type or of the tin type, may be used.

A suitable co-stabiliser may be epoxidized soybean oil, which may act synergistically with the stabiliser. Advantageously, the co-stabiliser may preferably be present in a mixture in a range from 2 phr to 6 phr, and even more preferably from 3.5 phr to 5 phr.

In the aforementioned plasticised PVC compound, any type of additive of the per se known type may be used, for example external and/or internal lubricants, heat stabilisers, UV stabilisers, pigments, antioxidants, antimicrobials, release agents, fungicides, antibacterial agents, process adjuvants, antistatic agents, fillers.

Advantageously, the aforementioned PVC matrix may be devoid of fillers, or it may contain a maximum of 5 phr. As a matter of fact, the use of fillers reduces the absorption of the plasticiser by the PVC matrix. The minimum amount indicated could be used for economic reasons, so as to lower the cost of the compound and therefore of the hose.

Where present, in the aforementioned plasticised PVC compound, any type of per se known filler may be used, for example calcium carbonate, kaolin, talc, mica, feldspar, wollastonite, natural silica, ceramic or glass microspheres, fibres or a vegetable filler according to the disclosures of application EP10003776.1.

A suitable lubricant may be Paraloid Paraloid K-125 ER (DOW) and/or Paraloid K-175 (DOW). Generally, one or more lubricants may be present at a value of about 0.3 phr.

Thanks to one or more of the aforementioned characteristics, the thermoplastic compound will be able to absorb relatively high amounts of plasticiser, hence the hose obtained therewith is highly flexible. Generally, each layer of hose obtained by means of the aforementioned compound may have a Shore A hardness measured according to UNI EN ISO 868 comprised between 30 Sh A and 60 Sh A, preferably between 30 Sh A and 50 Sh A.

The hose obtained with the aforementioned compound will also have excellent mechanical properties. The elongation at break measured according to UNI EN ISO 527 of each hose layer obtained by means of the aforementioned compound may have, as a matter of fact, a value comprised between 250% and 450%, and preferably 300% and 400%.

The hose obtained with the aforementioned compound will also last long over time.

As a matter of fact, each hose layer obtained by means of the aforementioned compound may preferably have a compatibility level of the plasticiser agent (B) in the PVC matrix (A) measured according to the ASTM D 3291 standard of 0 or 1, preferably 0.

Furthermore, each hose layer obtained by means of the aforementioned compound may generally have a cold flexibility—measured according to ASTM D 1043 standard—less than or equal to −49° C., preferably less than −70° C., more preferably less than −90° C.

Each hose layer obtained by means of the aforementioned compound may also have a volatility measured as indicated above comprised between 0.15% and 0.20%, preferably equal to 0.18%.

The flexible hose for transporting liquids according to the present invention may have at least one first layer made of the thermoplastic compound described above, and it may be obtained by extruding the latter in a per se known manner.

The flexible hose according to the present invention may include one or more layers, and it may be reinforced or not. In the case of multi-layer hoses, one or more of the layers may be made of the compound described above.

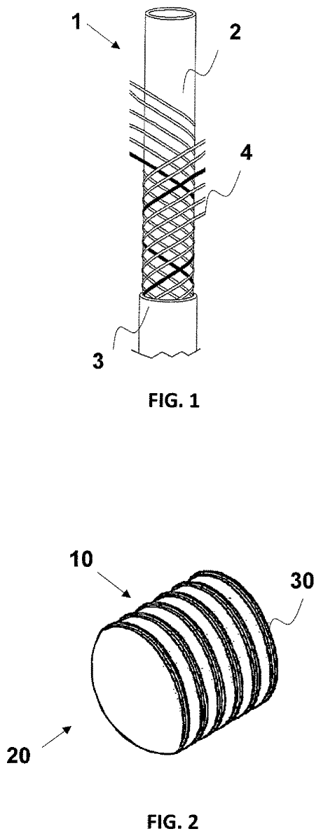

For example, FIG. 1 illustrates a multi-layer flexible hose 1 for transporting liquids, which may have a first layer 2 at contact with the fluid to be transported, a second outer layer 3 which can be gripped by a user and at least one reinforcement textile layer 4 interposed between the first layer 2 and the second layer 3. The latter may be both be made in the compound described above.

The spiralled hose 10 according to the present invention, whose portion is for example illustrated in FIG. 2, may include a main body 20 made of the compound described above and at least one reinforcement spiral 30 embedded therein.

In a per se known manner, the spiralled hose 10 may be made by extruding a webbing having a core made of a first polymeric material, for example plasticised PVC, and a shell made of the aforementioned compound.

Subsequently, in a per se known manner, the webbing may be spiral-wound on a spindle by joining the side walls thereof, so that the core forms the reinforcement spiral and the shell forms the main body.

Both in the case of the flexible hose 1 and of the spiralled hose 10, upon extrusion the aforementioned compound can be in granules, which may be prepared by means of the steps of:
mixing components (A) to (E) at at least one first predetermined temperature;
heating the mixture at a second predetermined temperature, preferably 140° C.;
cooling of the mixture to allow the formation of the granules;
extrusion of the granules of the compound, at a temperature range comprised between 155° C. and 185° C.

In particular, during the mixing step the plasticiser agent (B) may be added in progressive proportions: ⅓ of the plasticiser agent (B) at at least 40° C. and the remaining ⅔ at temperatures comprised between 80° C. and 100° C.

The invention will be described in greater detail with reference to the following examples which, in any case, shall not be deemed to limit the scope of protection of the invention.

### EXAMPLES

### Example 1—Absorption of Plasticisers

In order to evaluate the capacity of the aforementioned compound to absorb the plasticiser agent (B), various samples were prepared, as specified below. The following raw materials were used:
(A) Pvc matrix:
   PVC S 100 marketed by VINNOLIT® having the following characteristics:
      K factor—measured according to ISO 1628-2- of 99;
      particle size distribution—measured according to ISO 4610- of:
         85% of particles remaining on a 0.063 mm mesh sieve
         2% of particles remaining on a 0.250 mm mesh sieve;
      porosity measured in terms of absorption of plasticiser according to ISO 4608 equal to 45%;
      bulk density—measured according to ISO 60- of 0.440 g/ml.
   PVC S4170 marketed by VINNOLIT® having the following characteristics:
      K factor—measured according to ISO 1628-2- of 70;
      article size distribution—measured according to ISO 4610- of:
         97% of particles remaining on a 0.063 mm mesh sieve
         1% of particles remaining on a 0.250 mm mesh sieve;
      porosity measured in terms of absorption of plasticiser according to ISO 4608 equal to 34%;
      bulk density—measured according to ISO 60- of 0.480 g/ml.
(B) plasticiser agents: TOTM marketed by POLYNT and DIPLAST® TM/ST;
   DINP marketed by a EXXONMOBIL and Jayflex™ DINP Plasticizer;
   DOTP marketed by EASTMAN and Eastman 168™ non-phthalate plasticizer;
(C) stabiliser agent: Ca—Zn stabiliser marketed by TITANSTUC and ONE-PACK 1;
(D) additive: co-stabiliser: Epoxidized soybean oil marketed by AMIK PLASTIFICANTI SRL and KIMASOL DB.

The samples were prepared using a Brabender mixer, of the per se known type. The Shore A hardness was measured for each sample, according to UNI EN ISO 868.

The results are shown in table 1. Such table shows the values of the content of the mixture as regards the PVC matrix (A) and the plasticiser agent (B). For each sample, then, there are 1.23 phr of stabiliser agent and 5 phr of co-stabiliser in the mixture. All samples are devoid of fillers.

The first row of the table shows the type of PVC matrix (K70 or K100), while the second row shows the type of plasticiser.

TABLE 1

| K70 | | K100 | | K70 | | K100 | | K70 | | K100 | |
|---|---|---|---|---|---|---|---|---|---|---|---|
| DINP | | DINP | | DOTP | | DOTP | | TOTM | | TOTM | |
| Phr | Sh A | Phr | Sh A | Phr | Sh A | Phr | Sh A | Phr | Sh A | Phr | Sh A |
| 60 | 75 | 60 | 79 | 60 | 73 | 60 | 77 | 60 | 79 | 60 | 88 |
| 75 | 65 | 75 | 72 | 75 | 64 | 75 | 70 | 75 | 70 | 75 | 78 |
| 90 | 58 | 90 | 65 | 90 | 57 | 90 | 64 | 90 | 62 | 90 | 69 |
| 105 | 52 | 105 | 58 | 105 | 52 | 105 | 57 | 105 | 56 | 105 | 63 |
| n.a. | n.a. | 120 | 52 | n.a. | n.a. | 120 | 52 | 120 | 52 | 120 | 57 |
| n.a. | n.a. | 135 | 48 | n.a. | n.a. | 135 | 48 | n.a. | n.a. | 135 | 52 |
| n.a. | n.a. | 150 | 42 | n.a. | n.a. | 150 | 42 | n.a. | n.a. | 150 | 47 |
| n.a. | n.a. | 165 | 38 | n.a. | n.a. | 165 | 38 | n.a. | n.a. | 165 | 42 |
| n.a. | n.a. | 180 | 35 | n.a. | n.a. | 180 | 35 | n.a. | n.a. | 180 | 38 |
| n.a. | n.a. | 195 | 32 | n.a. | n.a. | 195 | 32 | n.a. | n.a. | 195 | 35 |
| n.a. | n.a. | 210 | 28 | n.a. | n.a. | 210 | 28 | n.a. | n.a. | 210 | 33 |

Table 1 shows obtaining compound having a hardness of less than 50 Sh A, requires to use a PVC matrix (A) having a K factor equal to 100 and at least 130 phr of plasticiser agent (B).

### Example 2—Mechanical Properties at Room Temperature

In order to compare the mechanical properties, the following samples were prepared:

| Sample A: Santoprene ® 201-64, marketed by EXXON | | |
|---|---|---|
| Sample B: PVC K 100 | 100 | phr |
| DOTP | 115 | phr |
| Ca—Zn | 1.5 | phr |
| Epoxidized soybean oil | 5 | phr |
| Sample C: PVC K 100 | 100 | phr |
| DOTP | 82 | phr |
| Ca—Zn | 1.5 | phr |
| Epoxidized soybean oil | 5 | phr |
| Sample D: PVC K 70 | 100 | phr |
| DOTP | 83 | phr |
| Ca—Zn | 1.5 | phr |
| Epoxidized soybean oil | 5 | phr |

The samples were produced according to UNI EN ISO 527 and UNI EN ISO 868.

The materials used were the same as those mentioned in example 1. For each of the samples A-D, the hardness according to the UNI EN ISO 868 standard and the tensile strength, the ultimate strength and the elongation at break according to the UNI EN ISO 527-1 standard were measured.

Such measurements were carried out before and after accelerated ageing at 80° C. for 168 hours in a forced air ventilation oven of the M250-VF type marketed by ATS FAAR Industries srl.

The results of such measurements are shown in Table 2, in which the average value of the values measured on 5 specimens for each of the aforementioned samples, before and after the aforementioned accelerated ageing is shown.

TABLE 2

| | | TENSILE | | ULTIMATE | | ELONGATION | |
|---|---|---|---|---|---|---|---|
| | | STRENGTH | | STRENGTH | | AT BREAK | |
| | HARDNESS | (N) | | (MPa) | | (%) | |
| SAMPLE | (Sh A) | BEFORE | AFTER | BEFORE | AFTER | BEFORE | AFTER |
| A | 64 | 21.7 | 21.6 | 6.0 | 6.0 | 524.25 | 479.14 |
| B | 48 | 38.9 | 32.7 | 8.5 | 7.7 | 377.7 | 298.81 |
| C | 60 | 32.3 | 33.7 | 7.5 | 7.8 | 242.10 | 227.21 |
| D | 62 | 50.6 | 49.3 | 12.2 | 11.9 | 443.97 | 390.32 |

Such table shows that the samples B and C (PVC K 100) have good mechanical properties, in line with or better than a TPE (Sample A) and in any case acceptable for the production of flexible or spiralled hoses.

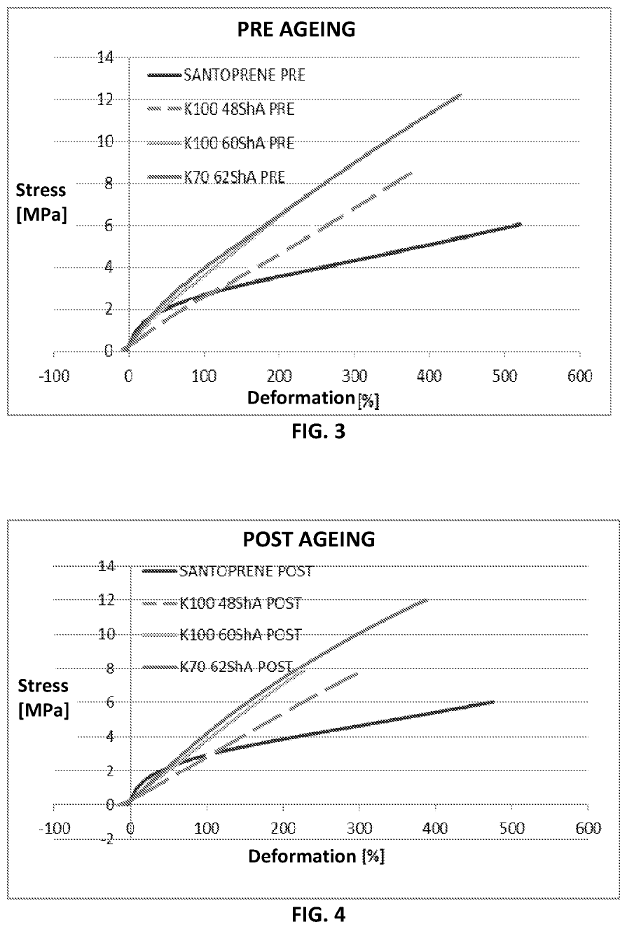

FIGS. 3 and 4 show the stress-strain curves for each of the aforementioned samples, in accordance with the UNI EN ISO 527-1 standard.

From a qualitative comparison it is clear that considering the same hardness (samples C and D) the PVC K 100 and the PVC K 70 basically show the same behaviour, whereas for lower hardness (sample B) the behaviour of PVC K 100 is more similar to that of a TPE than to that of an actual thermoplastic.

Furthermore, for each of the aforementioned samples A-D, the percentage level of shrinkage was also evaluated.

In particular, for each of them, three rectangular samples are made in plan view, of length 75 mm, width 10 mm and thickness 2 mm starting from one or more compound sheets produced by means of calendering.

The initial length Li of each sample is evaluated before introduction into a forced air ventilation oven of the M250-VF type marketed by ATS FAAR Industries srl, at 80° C. for 168 hours.

The final length L_{f} of each sample is then evaluated, upon exit from the oven.

Therefore, for each sample the percentage of longitudinal shrinkage is calculated using the following formula:

$$Shrinkage = \frac{{L}_{f} - Li}{{L}_{i}} * 100 ( \% )$$

Wherein:
Lₗ is the length of the sample before introduction into the oven;
L_{f} is the length of the sample after introduction into the oven.

The average of the values detected on the three different samples is then calculated. Table 3 shows the results of such test obtained on each of the three samples, as well as their resulting mean value, for each sample A-D, from which a good mechanical behaviour of the compounds containing PVC matrices (A) with K factor equal to 100 can be observed.

TABLE 3

SHRINKAGE [%]

| SAMPLE | VALUES | MEAN |
|---|---|---|
| K100 48 Sh A | 1.0 | 0.9 |
| | 0.8 | |
| | 0.8 | |
| K100 60 Sh A | 0.7 | 1.1 |
| | 1.7 | |
| | 1.0 | |
| K70 62 Sh A | 0.9 | 1.1 |
| | 1.8 | |
| | 0.6 | |
| SANTOPRENE | 0.3 | 0.2 |
| | 0.2 | |
| | 0.3 | |

### Example 3—Compatibility with the Plasticiser

For each of the aforementioned samples B-D, the compatibility level of the plasticiser was measured, in accordance with ASTM D 3291 standard.

TABLE 4

| | T = 23° C. | | | | T = 80° C. | | | | T = −5° C. | | | |
|---|---|---|---|---|---|---|---|---|---|---|---|---|
| SAMPLES | 2 h | 6 h | 24 h | 168 h | 2 h | 6 h | 24 h | 168 h | 2 h | 6 h | 24 h | 168 h |
| K100 48 ShA | 0/1 | 0/1 | 0 | 0 | 0 | 0 | 0 | 0 | 0 | 0 | 0 | 0 |
| K100 60 ShA | 0 | 0 | 0 | 0 | 0 | 0 | 0 | 0 | 0 | 0 | 0 | 0 |
| K70 62 ShA | 0 | 0 | 0 | 0 | 0 | 0 | 0 | 0 | 0 | 0 | 0 | 0 |

In the light of the above, it is clear that in compounds containing a PVC matrix having a K factor equal to 100 and a hardness comprised between 30 and 60 Sh A, migration is equal to substantially zero values.

### Example 4—Volatility of the Plasticiser

The volatility of the plasticiser was measured for each of the aforementioned samples A-D.

In particular, volatility was determined using three samples in the form of square plates in the plan view, with a side measuring 3 cm and a thickness equal to 2 mm, obtained from a sheet of compound manufactured by means of calendering, having the same dimensions to subject the surface height in question to heat. The samples are weighed so as to be subsequently arranged in the aforementioned forced air ventilation oven of the M250-VF type marketed by ATS FAAR Industries srl, at a predefined temperature, in the present example equal to 80° C. Volatility is then calculated as an average measurement of the possible percent weight loss of each sample after a sufficient time interval, in the present example equal to 168 h, at the aforementioned predefined temperature.

Below is the formula used for calculation:

$$Weight loss = \frac{{W}_{1} - {W}_{2}}{{W}_{1}} * 100 ( \% )$$

wherein:
W₁ is the weight of the sample at the beginning of the test;
W₂ is the weight of the sample at the end of the test.

The results obtained are shown in Table 5, and they show the comparability of the compounds containing Santoprene® and of the compounds comprising PVC matrices (A) having K factor equal to 100 and hardness equal to 48 or 60 Sh A, despite the high plasticiser content.

TABLE 5

SHRINKAGE [%]

| SAMPLE | VALUES | MEAN |
|---|---|---|
| K100 48 Sh A | 0.1 | 0.1 |
| | 0.1 | |
| | 0.1 | |
| K100 60 Sh A | 0.2 | 0.1 |
| | 0.1 | |
| | 0.1 | |
| K70 62 Sh A | 0.3 | 0.2 |
| | 0.2 | |
| | 0.2 | |
| SANTOPRENE | 0.1 | 0.1 |
| | 0.1 | |
| | 0.1 | |

### Example 5—Mechanical Properties at Low Temperatures

Samples E and F were prepared using the materials of example 1 and according to the following formulations.

| | | |
|---|---|---|
| Sample E: PVC K 100 | 100 | phr |
| DINP | 90 | phr |
| Ca—Zn | 1.5 | phr |
| Epoxidized soybean oil | 5 | phr |
| Sample F: PVC K 100 | 100 | phr |
| DINP | 170 | phr |
| Ca—Zn | 1.5 | phr |
| Epoxidized soybean oil | 5 | phr |

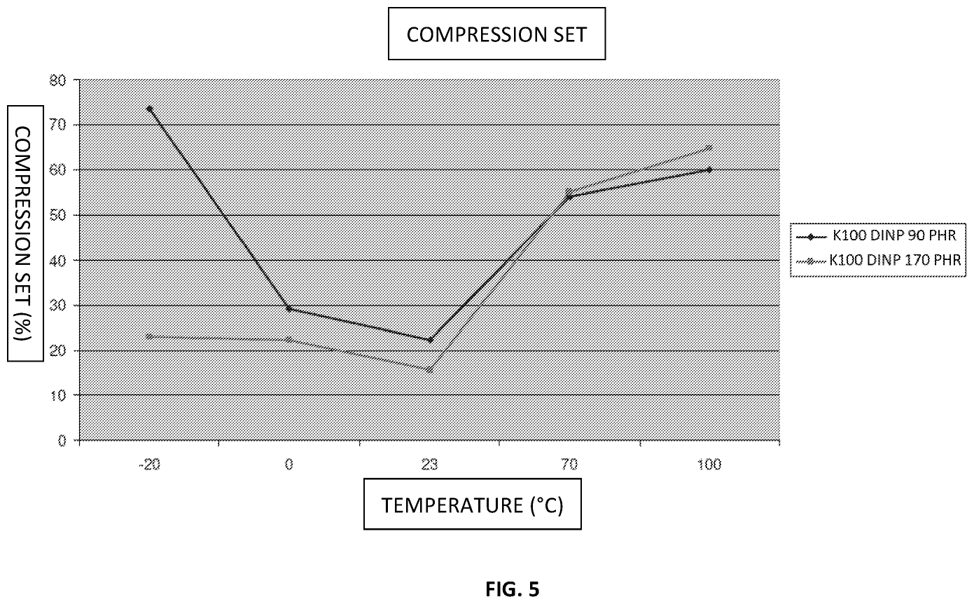

FIG. 5 shows the chart of the compression deformation measured according to the DIN ISO 815-1 standard Method A, between −20° C. and 100° C.

Such chart shows that while at high temperatures the behaviour between samples E and F is similar, at low temperatures the sample F has a considerably better behaviour.

Samples G-L were prepared using the materials of example 1 and according to the following formulations.

| | | |
|---|---|---|
| Sample G: PVC K 70 | 100 | phr |
| DINP | 50 | phr |
| Ca—Zn | 1.5 | phr |
| Epoxidized soybean oil | 5 | phr |
| Sample H: PVC K 70 | 100 | phr |
| DINP | 90 | phr |
| Ca—Zn | 1.5 | phr |
| Epoxidized soybean oil | 5 | phr |
| Sample I: PVC K 100 | 100 | phr |
| DINP | 120 | phr |
| Ca—Zn | 1.5 | phr |
| Epoxidized soybean oil | 5 | phr |
| Sample L: PVC K 100 | 100 | phr |
| DINP | 210 | phr |
| Ca—Zn | 1.5 | phr |
| Epoxidized soybean oil | 5 | phr |

For such samples, alongside the aforementioned sample F, the glass transition temperature was evaluated using the dynamic-mechanical thermal analysis (DMTA) method.

Such method of analysis, also known as dynamic mechanical spectroscopy, provides for, as known, the application of a small cyclic deformation on a sample to measure its resulting stress response, or equivalently, it provides for imposing a cyclic stress on the sample itself to measure the resulting deformation response.

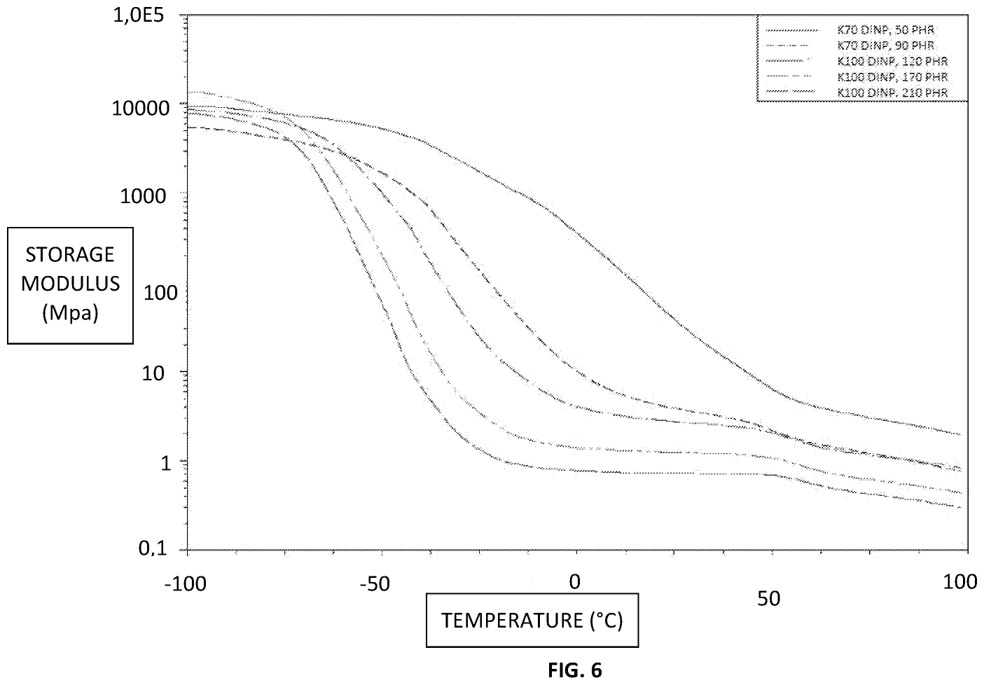

FIG. 6 shows the development of the elastic modulus as a function of the increasing temperature.

It is clear that the elastic modulus of the compounds containing a PVC matrix (A) having K factor equal to 100 remains substantially constant in a wide temperature range.

The result is high flexibility and good mechanical properties at low temperatures, with considerable advantages in terms of using the same material which may have greater resistance to cracking if subjected to very low temperatures.

Furthermore, table 6 shows the temperature of cold flexibility measured according to the ASTM D1043 standard for samples with a hardness lower than 60 Sh A and containing different types of PVC matrices (A) and plasticiser agents (B). For each of these samples, a stabiliser agent the Ca—Zn type was used with respect to 1.5 phr and a co-stabiliser of epoxidized soybean oil with respect to 5 phr. The materials used are those of example 1 above.

TABLE 6

| Resin PVC | Hardness | Density | Plasticiser agent | Cold flexibility |
|---|---|---|---|---|
| (A) | [Sh A] | [g/cc] | (B) | temperature |
| K100 | 48 | 1.135 | DOTP | −92 |
| K100 | 54 | 1.154 | DOTP | −51 |
| K70 | 55 | 1.160 | TOTM | −62 |
| K70 | 52 | 1.160 | TOTM/DOA | −59 |
| | | | (50%/50%) | |
| K70 | 53 | 1.160 | DOTP/DOA | −67 |
| | | | (50%/50%) | |
| K70 | 54 | 1.170 | DOTP | −49 |

It is clear that for hardness higher than 50 Sh A, the cold flexibility temperature seems to be similar among the different compounds, but considering a Shore hardness value lower than 50 Sh A, higher performance is obtained with PVC matrices (A) having a K factor equal to 100.

This further confirms the optimal behaviour of PVC compounds having K factor of 100.

### Example 6—Manufacturing Flexible Hoses

Various hose samples were made using the aforementioned compounds (samples A-D), according to the following Table 7. Each of the hose samples provided has an inner layer at contact with the fluid to be transported, an outer layer which can be gripped by a user and a reinforcement textile layer interposed between the two layers.

TABLE 7

| | | | REINFORCEMENT | | Non- | | | |
|---|---|---|---|---|---|---|---|---|
| | | | TEXTILE | Weight | thermoformed | | | |
| | INNER LAYER | OUTER LAYER | LAYER | [g/m [symbol] ] | hose | [ft] | [m] | [kg] |
| S1 | PVC K100 (48 Sh A) | PVC K100 (48 Sh A) | PET 1100 dtex Z0 | 89.0 | 38.0 | 50 | 15.24 | 1.356 |
| % (weight/weight) | 44 | 35 | 10 | | | | | |
| S2 | PVC K70 (62 ShA) | PVC K70 (62 ShA) | PET 1100 dtex Z0 | 88.0 | 43.0 | 50 | 15.24 | 1.341 |
| % (weight/weight) | 44 | 34 | 10 | | | | | |
| S3 | PVC K70 (62 ShA) | PVC K100 (48 Sh A) | PET 1100 dtex Z0 | 90.0 | 44.0 | 50 | 15.24 | 1.372 |
| % (weight/weight) | 46 | 34.5 | 9.5 | | | | | |
| S4 | PVC K100 (48 Sh A) | PVC K100 (48 Sh A) | PET 1100 dtex Z0 | 86.0 | 42.0 | 50 | 15.24 | 1.311 |
| % (weight/weight) | 42.5 | 33.5 | 10 | | | | | |
| S5 | PVC K100 (48 Sh A) | PVC K100 (60 Sh A) | PET 1100 dtex Z0 | 89.0 | 43.0 | 50 | 15.24 | 1.356 |
| % (weight/weight) | 42 | 37 | 10 | | | | | |
| S7 | Santoprene | Santoprene | PET 1100 dtex Z0 | 88.0 | 38.0 | 50 | 15.24 | 1.341 |
| % (weight/weight) | 43.5 | 34 | 10.5 | | | | | |

[symbol]

indicates data missing or illegible when filed

Such samples S1, S2, S3, S4, S5, S7 were subjected to some tests to evaluate in particular the percentage level of shrinkage thereof following accelerated aging, keeping the samples in an oven at 80° C. for 168 hours, in accordance with the above. Table 8 shows the results obtained.

TABLE 8

| SAMPLE | SHRINKAGE (%) |
|---|---|
| S1 | 3.7 |
| S2 | 4.7 |
| S3 | 4.5 |
| S4 | 3.7 |
| S5 | 5.5 |
| S7 | 0.3 |

It can be observed that, in samples having a hardness lower than 50 Sh A and PVC matrices (A) having a K factor equal to 100 both in the inner coating and in the outer coating, shrinkage is better than in hoses obtained with compounds containing PVC matrices (A) with a K factor of 70.

Table 9 shows the results of the volatility test carried out on the aforementioned samples S1, S2, S5 and S7, under the aforementioned conditions of conducting such test.

TABLE 9

| | |
|---|---|
| WEIGHT [g] | VOLATILITY [%] |

| SAMPLE | before | After | | Average |
|---|---|---|---|---|
| S1 | 0.6067 | 0.6056 | 0.18 | 0.18 |
| | 0.5636 | 0.5626 | 0.18 | |
| | 0.8347 | 0.8333 | 0.17 | |
| S5 | 0.6387 | 0.6384 | 0.05 | 0.14 |
| | 0.7255 | 0.7241 | 0.19 | |
| | 0.846 | 0.8446 | 0.17 | |
| S2 | 1.3595 | 1.3548 | 0.35 | 0.32 |
| | 0.9422 | 0.9392 | 0.32 | |
| | 0.8687 | 0.8662 | 0.29 | |
| S7 | 0.8985 | 0.8981 | 0.04 | 0.05 |
| | 0.7152 | 0.7148 | 0.06 | |
| | 0.7989 | 0.7986 | 0.04 | |

It is clear that the volatility test shows a good behaviour of the compounds containing PVC matrices (A) having K factor equal to 100, in particular with respect to PVC matrices having K factor equal to 70.

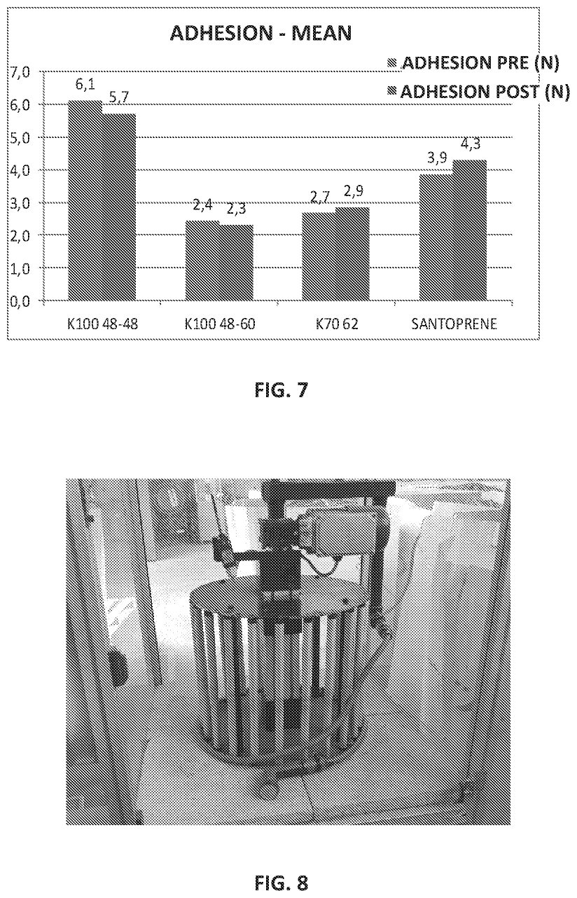

FIG. 7 shows the average degree of adhesion detected between the layers forming the hose.

Adhesion was measured according to UNI EN ISO 8033 and UNI ISO 6133.

As observable, the compounds containing a PVC matrix (A) with a K factor equal to 100 and hardness of the inner and outer hose layers equal to 48 Sh A show an excellent mutual adhesion, despite the high percentage of plasticiser present in the compound.

Table 10 shows the results of the drilling test carried out in accordance with BS EN 12568:2010, showing the best yield of the compounds containing PVC matrices (A) with a K factor equal to 100 and a hardness equal to 48 Sh A with respect to PVC matrices with a hardness higher than 60 Sh A.

TABLE 10

| | | Strength measured |
|---|---|---|
| MATERIAL | DESCRIPTION | at break (N) |
| PVC K 100 | 48 Sh A inner layer - 48 | 26.08 |
| | Sh A outer layer | |
| TPV - SANTOPRENE | 59 Sh A inner layer - 69 | 16.31 |
| | Sh A outer layer | |
| TPV - SANTOPRENE | 69 Sh A inner layer - 69 | 18.20 |
| | Sh A outer layer | |
| TPV - SANTOPRENE | 69 Sh A inner layer - 59 | 23.98 |
| | Sh A outer layer | |

The results relating to the abrasion test carried out on a hose having a length of about 1 m, filled with water at an internal pressure of 3 bar, are also shown.

Such hose was dragged on an outdoor floor at room temperature, as shown in FIG. 8.

In particular, the dragging speed is 2000 m/h, the weight per meter of the water-filled hose is equal to 160 g/m and the covered dragging distance equal to 1000 m.

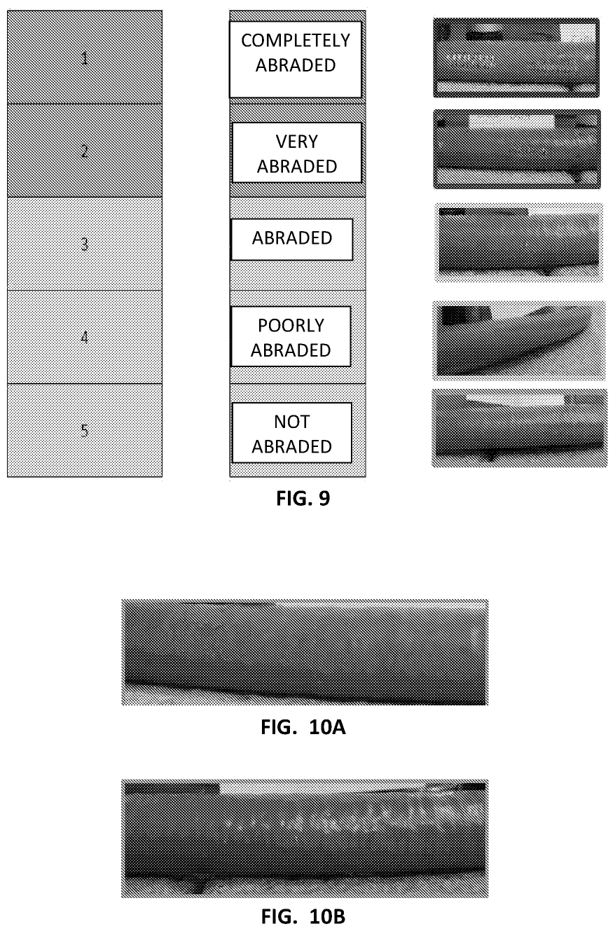

The sample was then inspected visually by comparing the degree of abrasion with the degrees of abrasion shown in the key of FIG. 9, in which the identified acceptance limit is equal to 4.

The abrasion test was carried out before and after accelerated ageing of the sample, carried out according to the method mentioned above.

In particular, FIG. 10A shows the hose subjected to the abrasion test prior to the accelerated ageing test, while FIG. 10B shows the hose subjected to the abrasion test after the accelerated ageing of the sample.

Both results show that the sample has a degree of abrasiveness equal to 5, therefore definable ‘non-abraded’ according to the key of FIG. 9.

### Example 7—Manufacturing Spiralled Hoses

The compound of sample C above was tested for the manufacturing a spiralled hose, with a rigid PVC reinforcement spiral.

Specifically, a spiralled hose with an internal diameter of 152 mm and 76 mm was made.

In light of the above, it is clear that the hose has good cold flexibility, and can therefore be used in applications requiring such type of performance. For example, this hose can be used in swimming pool or SPA facilities.

The invention claimed is:

1.-16. (canceled)

17. A flexible or spiraled hose for transporting fluids manufactured at least in part from a thermoplastic compound consisting of:
(A) 100 phr of a PVC matrix in suspension;
(B) from 100 phr to 250 phr of a plasticizer agent;
(C) from 0.5 phr to 5 phr of a stabilizer agent;
(D) from 0.1 to 10 phr of a co-stabilizer agent; and
(E) from 0 to 10 phr of an additive,
wherein the PVC matrix has a K factor measured according to DIN EN ISO 1628-2 greater than or equal to 98, and
wherein the thermoplastic compound has a Shore A hardness measured according to UNI EN ISO 868 comprised between 30 Sh A and 60 Sh A.

18. The flexible or spiraled hose according to claim 17, wherein the PVC matrix is devoid of fillers or it contains a maximum of 5 phr of a filler.

19. The flexible or spiraled hose according to claim 17, wherein the PVC matrix has a particle size distribution, measured according to DIN EN ISO 4610, of:
no more than 90% of particles remaining on a 0.063 mm mesh sieve; and
not more than 5% of the particles remaining on a 0.250 mm mesh sieve.

20. The flexible or spiraled hose according to claim 17, wherein the PVC matrix has a K factor, measured according to DIN EN ISO 1628-2, equal to 99 or 100.

21. The flexible or spiraled hose according to claim 17, wherein the PVC matrix is made of particles having a porosity, measured in terms of plasticizer absorption according to DIN 53417/1, comprised between 35% and 55%.

22. The flexible or spiraled hose according to claim 17, wherein the PVC matrix is a resin in suspension having a bulk density, calculated according to UNI EN ISO 60, comprised between 0.400 g/ml and 0.500 g/ml.

23. The flexible or spiraled hose according to claim 17, wherein the plasticizer agent (B) is present in a content comprised between 120 phr and 250 phr.

24. The flexible or spiraled hose according to claim 17, wherein an elongation at break of the thermoplastic compound, measured according to UNI EN ISO 527, is comprised between 250% and 450%.

25. The flexible or spiraled hose according to claim 17, wherein the thermoplastic compound has a compatibility level of the plasticizer agent in the PVC matrix measured according to the ASTM D 3291 standard of 0 or 1.

26. The flexible or spiraled hose according to claim 17, wherein the thermoplastic compound has a cold flexibility, measured according to ASTM D 1043, of less than or equal to −49° C.

27. The flexible or spiraled hose according to claim 17, wherein the flexible or spiraled hose is a flexible hose having at least one first layer made of the thermoplastic compound.

28. The flexible or spiraled hose according to claim 27, wherein the flexible hose has the at least one first layer made of the thermoplastic compound and disposed to be contact with a fluid to be transported, the flexible hose further comprising at least one second outer layer made of the thermoplastic compound and disposed to be gripped by a user, the flexible hose further comprising at least one reinforcement textile layer interposed between the at least one first layer and at least one second layer.

29. The flexible or spiraled hose according to claim 17, wherein the flexible or spiraled hose is a spiraled hose comprising a main body made of the thermoplastic compound and a reinforcement spiral embedded therein.

30. A method of manufacturing a flexible hose according to claim 27, comprising:
extruding a tubular body,
wherein extruding the tubular body comprises extruding the thermoplastic compound to obtain the at least one first layer.

31. The method according to claim 30, wherein extruding the thermoplastic compound comprises extruding the thermoplastic compound configured as granules prepared by:
mixing components (A) to (E) at a first predetermined temperature to provide a mixture;
heating the mixture at a second predetermined temperature;
cooling the mixture; and
extruding the cooled mixture to obtain the granules.

32. A method of manufacturing a spiraled hose according to claim 29, comprising:
extruding a strip having a core made of a first polymeric material and a shell made of the thermoplastic compound; and
spiral winding the strip on a spindle to obtain the spiraled hose,
thereby producing the main body made of the thermoplastic compound and the reinforcement spiral embedded therein

33. The method according to claim 31, wherein extruding the thermoplastic compound comprises extruding the thermoplastic compound configured as granules prepared by:
mixing components (A) to (E) at a first predetermined temperature to provide a mixture;
heating the mixture at a second predetermined temperature;
cooling the mixture; and
extruding the cooled mixture to obtain the granules.
